(19) United States
(12) Patent Application Publication
(10) Pub. No.: US 2025/0324497 A1
(43) Pub. Date: Oct. 16, 2025

(54) LIGHT-EMITTING DIODE DEVICES WITH INDIVIDUALLY ADJUSTABLE PULSE WIDTH MODULATION SIGNALS AND RELATED METHODS

(71) Applicant: CreeLED, Inc., Durham, NC (US)

(72) Inventor: Christopher P. Hussell, Raleigh, NC (US)

(21) Appl. No.: 18/806,800

(22) Filed: Aug. 16, 2024

Related U.S. Application Data
(60) Provisional application No. 63/632,582, filed on Apr. 11, 2024.

(51) Int. Cl. H05B 45/325

(52) U.S. Cl. CPC H05B 45/325

(57) ABSTRACT

Light-emitting diode (LED) devices and, more particularly, LED packages with individually adjustable pulse width modulation (PWM) signals and related methods are disclosed. LED devices, such as LED packages, with variable PWM signals include the ability to provide one or more of PWM phase control, PWM period count control, controllable blanking times, and intra-blanking signaling. LED packages are configured for receiving and transmitting digital communication signals. An integrated active electrical element within each LED package is configured to drive the LED chip by PWM while providing such variable PWM relative to other LED packages to more evenly distribute power draws and capacitance requirements in corresponding systems.

### RELATED APPLICATIONS

This application claims the benefit of U.S. provisional patent application Ser. No. 63/632,582, filed Apr. 11, 2024, the disclosure of which is hereby incorporated herein by reference in its entirety.

### FIELD OF THE DISCLOSURE

The present disclosure relates to light-emitting diode (LED) devices and, more particularly, to LED packages with individually adjustable pulse width modulation signals and related methods.

### BACKGROUND

Light-emitting diodes (LEDs) are solid-state devices that convert electrical energy to light and generally include one or more active layers of semiconductor material (or an active region) arranged between oppositely doped n-type and p-type layers. When a bias is applied across the doped layers, holes and electrons are injected into the one or more active layers where they recombine to generate emissions such as visible light or ultraviolet emissions.

LEDs have been widely adopted in various illumination contexts, for backlighting of liquid crystal display (LCD) systems (e.g., as a substitute for cold cathode fluorescent lamps) and for direct-view LED displays. Applications utilizing LED arrays include vehicular headlamps, roadway illumination, light fixtures, and various indoor, outdoor, and specialty contexts. Desirable characteristics of LED devices include high luminous efficacy and long lifetime.

Large format multi-color direct-view LED displays (including full color LED video screens) typically include numerous individual LED panels, packages, and/or components providing image resolution determined by the distance between adjacent pixels. Direct-view LED displays typically include three-color displays with arrayed red, green, and blue (RGB) LEDs, and two-color displays with arrayed red and green (RG) LEDs. For many LED display systems, it is desirable to form LED color groups for each pixel such as primary colors red, green, and blue (RGB) that define vertices of a triangle (or polygon) on a chromaticity diagram. This polygon defines the so-called color gamut of the display device, the area of which describes all the possible colors that the display device is capable of producing. Driver printed circuit boards for controlling LED displays are typically densely populated with electrical devices including capacitors, field effect transistors (FETs), decoders, microcontrollers, and the like for driving the pixels of the display. As pixel pitches continue to decrease for higher resolution displays, the density of such electrical devices scales higher corresponding to the increased number of pixels for a given panel area. This tends to add higher complexity and costs to LED panels for display applications.

The art continues to seek improved LED array devices with small pixel pitches while overcoming limitations associated with conventional devices and production methods.

### SUMMARY

The present disclosure relates to light-emitting diode (LED) devices and, more particularly, to LED packages with individually adjustable pulse width modulation (PWM) signals and related methods. LED devices, such as LED packages, with variable PWM signals include the ability to provide one or more of PWM phase control, PWM period count control, controllable blanking times, and intra-blanking signaling. LED packages are configured for receiving and transmitting digital communication signals. An integrated active electrical element within each LED package is configured to drive the LED chip by PWM while providing such variable PWM relative to other LED packages to more evenly distribute power draws and capacitance requirements in corresponding systems.

In one aspect, an LED package configured for receiving and transmitting digital communication signals comprises: an LED chip; an LED driver configured to drive the LED chip by pulse width modulation (PWM); and a PWM processor coupled to the LED driver of the LED chip, the PWM processor configured to provide an adjustable PWM phase in a PWM output signal to the LED driver for driving the LED chip. In certain embodiments, the PWM processor is configured to receive a nonzero initial PWM counter value to provide the adjustable PWM phase. In certain embodiments, the PWM processor is configured to segment a PWM period of the PWM output signal into a plurality of sub-periods. In certain embodiments, a period of each frame of the PWM output signal is not an exact integer multiple of a PWM period of the PWM output signal such that a phase of the PWM output signal accumulates between each successive frame, and the phase continues with each successive frame from a point where it was stopped in a previous frame. In certain embodiments: the PWM processor is configured to provide a blanking time before the start of a PWM period of the PWM output signal; and the PWM processor is configured to adjust a length of the blanking time to adjust a start time for the start of the PWM period. In certain embodiments: the PWM processor is configured to provide a blanking time before the start of a PWM period of the PWM output signal; and the PWM processor is configured to provide an intra-blanking signal to the LED driver during the blanking time. In certain embodiments, the PWM processor is configured to provide a selectable number of PWM periods per frame in the PWM output signal. In certain embodiments, the PWM processor is configured to receive an input signal designating the selectable number of PWM periods. In certain embodiments, the selectable number of PWM periods comprises continuous PWM periods until a stop event.

In another aspect, a method light output control within an LED package comprises: receiving an input brightness value for an LED chip within the LED package; and producing a pulse width modulation (PWM) output signal within the LED package for electrically activating the LED chip according to the input brightness value, the PWM output signal comprising an adjustable PWM phase. The method may further comprise receiving a nonzero initial PWM counter value to produce the adjustable PWM phase. The method may further comprise segmenting a PWM period of the PWM output signal into a plurality of sub-periods. In certain embodiments, a period of each frame of the PWM output signal is not an exact integer multiple of a PWM period of the PWM output signal such that a phase of the PWM output signal accumulates between each successive frame, and the phase continues with each successive frame from a point where it was stopped in a previous frame. The method may further comprise producing a blanking time before the start of a PWM period of the PWM output signal; and adjusting a length of the blanking time to adjust a start time for the start of the PWM period. The method may further comprise producing a blanking time before the start of a PWM period of the PWM output signal; and producing an intra-blanking signal during the blanking time.

In another aspect, an LED display comprises: a display panel; and at least one LED package comprising: an LED chip; an LED driver configured to drive the LED chip by pulse width modulation (PWM); and a PWM processor coupled to the LED driver of the LED chip, the PWM processor configured to provide an adjustable PWM phase in a PWM output signal to the LED driver for driving the LED chip. In certain embodiments, the PWM processor is configured to receive a nonzero initial PWM counter value to provide the adjustable PWM phase. In certain embodiments, the PWM processor is configured to segment a PWM period of the PWM output signal into a plurality of sub-periods. In certain embodiments, a period of each frame of the PWM output signal is not an exact integer multiple of a PWM period of the PWM output signal such that a phase of the PWM output signal accumulates between each successive frame, and the phase continues with each successive frame from a point where it was stopped in a previous frame. In certain embodiments: the PWM processor is configured to provide a blanking time before the start of a PWM period of the PWM output signal; and the PWM processor is configured to adjust a length of the blanking time to adjust a start time for the start of the PWM period. In certain embodiments: the PWM processor is configured to provide a blanking time before the start of a PWM period of the PWM output signal; and the PWM processor is configured to provide an intra-blanking signal to the LED driver during the blanking time. In certain embodiments, the PWM processor is configured to provide a blanking time during each frame of the PWM output signal, and the blanking time is synchronized to an external signal received from other equipment external to the LED display.

In another aspect, a method of light output control for an LED device comprises: sending a digital communication signal to a plurality of serially connected LED packages; and electrically activating LED chips within each LED package of the plurality of serially connected LED packages during a frame such that an overall current draw for the plurality of serially connected LED packages is defined during the frame, and the overall current draw forms a profile with curved edges. In certain embodiments, electrically activating LED chips within each LED package of the plurality of serially connected LED packages comprises: providing a first pulse width modulation (PWM) phase for a first LED package of the plurality of serially connected LED packages; and providing a second PWM phase for a second LED package of the plurality of serially connected LED packages, wherein the second PWM phase is offset from the first PWM phase. In certain embodiments, the first PWM phase is provided by a first PWM processor of the first LED package, and the second PWM phase is provided by a second PWM processor of the second LED package. The method may further comprise: providing a first blanking time for the first LED package within the frame; and providing a second blanking time for the second LED package within the frame, wherein a start time or an end time of the second blanking time is offset from a start time or an end time of the first blanking time.

In another aspect, an LED package configured for receiving and transmitting digital communication signals comprises: an LED chip; an LED driver configured to drive the LED chip by pulse width modulation (PWM); and a PWM processor coupled to the LED driver of the LED chip, the PWM processor configured to provide a PWM output signal with a selectable number of PWM periods per frame to the LED driver for driving the LED chip. In certain embodiments, the selectable number of PWM periods comprises selection of one, two, or three PWM periods. In certain embodiments, the selectable number of PWM periods comprises continuous PWM periods until a stop event. In certain embodiments, the selectable number of PWM periods is configured to be restarted by a command signal received by the PWM processor. In certain embodiments, the PWM processor is configured to receive an input signal designating the selectable number of PWM periods. In certain embodiments, the PWM processor is configured to provide an adjustable PWM phase in the PWM output signal. In certain embodiments, the adjustable PWM phase is offset from a start of the selectable number of PWM periods. In certain embodiments, the PWM processor is configured to receive a nonzero initial PWM counter value to provide the adjustable PWM phase. In certain embodiments, the PWM processor is configured to segment each PWM period of the selectable number of PWM periods into a plurality of sub-periods. In certain embodiments, the plurality of sub-periods is offset from a start of the selectable number of PWM periods. In certain embodiments, a period of each frame is not an exact integer multiple of each PWM period of the number of selectable PWM periods such that a phase of the PWM output signal accumulates between each frame. In certain embodiments: the PWM processor is configured to provide a blanking time during each frame; and the PWM processor is configured to adjust a length of the blanking time to provide an adjustable start time for the selectable number of PWM periods within each frame. In certain embodiments: the PWM processor is configured to provide a blanking time during each frame; and the PWM processor is configured to provide an intra-blanking signal to the LED driver during the blanking time.

In another aspect, a method of light output control within an LED package comprises: receiving an input brightness value for an LED chip within the LED package; and producing a pulse width modulation (PWM) output signal within the LED package for electrically activating the LED chip according to the input brightness value, the PWM output signal comprising a selectable number of PWM periods per frame. In certain embodiments, the selectable number of PWM periods comprises selection of one, two, or three PWM periods. In certain embodiments, the selectable number of PWM periods comprises continuous PWM periods until a stop event. The method may further comprise restarting the selectable number of PWM periods with a command signal. The method may further comprise receiving an input signal designating the selectable number of PWM periods. The method may further comprise adjusting a PWM phase in the PWM output signal. The method may further comprise providing a blanking time during each frame, and adjusting a length of the blanking time to provide an adjustable start time for the selectable number of PWM periods within each frame. The method may further comprise providing a blanking time during each frame, and providing an intra-blanking signal during the blanking time.

In another aspect, an LED display comprises: a display panel; and at least one LED package comprising: an LED chip; an LED driver configured to drive the LED chip by pulse width modulation (PWM); and a PWM processor coupled to the LED driver of the LED chip, the PWM processor configured to provide an output with a selectable number of PWM periods per frame in a PWM output signal to the LED driver for driving the LED chip. In certain embodiments, the selectable number of PWM periods comprises selection of one, two, or three PWM periods. In certain embodiments, the selectable number of PWM periods comprises continuous PWM periods until a stop event. In certain embodiments, the selectable number of PWM periods is configured to be restarted by a command signal received by the PWM processor. In certain embodiments, the PWM processor is configured to receive an input signal designating the selectable number of PWM periods. In certain embodiments, the PWM processor is configured to provide an adjustable PWM phase in the PWM output signal. In certain embodiments, the adjustable PWM phase is offset from a start of the selectable number of PWM periods. In certain embodiments: the PWM processor is configured to provide a blanking time during each frame; and the PWM processor is configured to adjust a length of the blanking time to provide an adjustable start time for the selectable number of PWM periods within each frame. In certain embodiments: the PWM processor is configured to provide a blanking time during each frame; and the PWM processor is configured to provide an intra-blanking signal to the LED driver during the blanking time. In certain embodiments, the PWM processor is configured to provide a blanking time during each frame, and the blanking time is synchronized to an external signal received from other equipment external to the LED display.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram illustrating a system level control scheme for a lighting device using cascade communication for serially connected light-emitting diode (LED) packages.

FIG. 2A is a block diagram of an LED package from FIG. 1 capable of providing pulse width modulation (PWM) signals with adjustable PWM phase and/or period according to principles of the present disclosure.

FIG. 2B is a schematic diagram of a portion of the LED package of FIG. 2A illustrating details of a PWM processor according to principles of the present disclosure.

FIG. 3 is an illustration depicting a comparison of various exemplary PWM signals relative to two successive frames according to aspects of the present disclosure.

FIG. 4 is an illustration depicting two successive frames with two PWM periods per frame for four LED pixels of an LED display according to aspects of the present disclosure.

FIG. 5 is an illustration depicting a comparison of exemplary PWM signals relative to two successive frames according to further aspects of the present disclosure.

FIG. 6 is an illustration depicting a current draw comparison for various PWM signals relative to two successive frames according to aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

The present disclosure relates to light-emitting diode (LED) devices and, more particularly, to LED packages with individually adjustable pulse width modulation (PWM) signals and related methods. LED devices, such as LED packages, with variable PWM signals include the ability to provide one or more of PWM phase control, PWM period count control, controllable blanking times, and intra-blanking signaling. LED packages are configured for receiving and transmitting digital communication signals. An integrated active electrical element within each LED package is configured to drive the LED chip by PWM while providing such variable PWM relative to other LED packages to more evenly distribute power draws and capacitance requirements in corresponding systems.

In cascade digital communication, multiple electronic devices are arranged as repeaters to successively receive serial communication for operation. In the context of fine-pitch video displays, multiple LED packages are serially arranged as LED pixels to receive cascade communication. Incoming signals to each LED pixel are produced by another element, such as a master controller or the previous LED pixel, and the bitstream of incoming signals is derived from clock domains of one or more preceding devices. Proper distribution of communication signals to thousands of LED pixels creates challenges. Small sizes are required for LED packages to form pixels of high-resolution video displays and these size constraints provide further challenges.

As used herein, the terms “data stream” and “communication channel” may at times be used interchangeably. However, a “data stream” generally refers to a non-physical representation of data over time that flows through a set of at least one communication channel as well as the internal wiring and storage registers within various elements such as controllers and active electrical elements. A data stream may also be referred to as digital communication between two elements, such as a controller element that transmits digital communication and a receiver element that receives the digital communication. A “communication channel” generally refers to a physical medium through which the data stream is conveyed. For example, a communication channel may comprise a wire with associated electrical elements, an optical fiber, or even air as in the case of radio, light, or sound waves. A given physical channel could also be divided up in time or frequencies to allow multiple “communication channels” within one medium at once such as changing to a different frequency band. In certain aspects, communication channels may embody serial digital communication channels. Certain aspects relate to a binary communication channel that is a single wire referenced to a common conductor such as ground, which commonly can only hold one value at a time which is low or high voltage (e.g., digital “0” or “1”) and is controlled by the output register of the preceding device. Two-wire differential signaling methods are also contemplated, but the preferred embodiment shown here refers to the single-wire approach primarily because of the added complexity of providing more traces with fine pitch displays.

In certain aspects, the present disclosure relates to light-emitting devices including LEDs, LED packages, and related LED displays and, more particularly, to active control of LEDs within LED displays. LED displays may include rows and columns of LEDs that form an array of LED pixels. A particular LED pixel may include a cluster of LED chips of the same color or multiple colors, with an exemplary LED pixel including a red LED chip, a green LED chip, and a blue LED chip. In certain embodiments, an LED package includes a plurality of LED chips that form at least one LED pixel, and a plurality of such LED packages may be arranged to form an array of LED pixels for an LED display. Each LED package may include its own active electrical element that is configured to receive a control signal and actively maintain an operating state, such as brightness or grey level or a color select signal for the LED chips of the LED device while other LED devices are being addressed. In certain embodiments, the active electrical element may include active circuitry that includes one or more of a driver device, a signal conditioning or transformation device, a memory device, a decoder device, an electrostatic discharge (ESD) protection device, a thermal management device, a detection device, a voltage and/or current sensing device, a command processing device, and other circuitry, among others. The active electrical element further includes circuitry to facilitate communication with multiple uncorrelated clock domains, including an original clock domain from a controller and a local clock domain derived within the active electrical element. In this regard, each LED pixel of an LED display may be configured for operation with active matrix addressing with mixed clock domain communication. The active electrical element may be configured to receive one or more of an analog control signal, an encoded analog control signal, a digital control signal, and an encoded digital control signal. In such arrangements, strings of LED packages, each with their own active electrical element, may be arranged for serial communication where each active electrical element receives data from a data stream and transmits data to the next active electrical element in the string of LED packages.

For active matrix addressing, each LED pixel is configured to actively maintain an operating state or otherwise control the driving state, such as brightness or grey level or color select, while other LED pixels are being addressed, thereby allowing each LED pixel to maintain or otherwise independently control their driving state and provide improved display and/or image recording with photographic equipment by reducing or eliminating effects caused by lower-frequency pulsing beating of the display light output with other non-synchronized equipment (e.g., lighting sources, other pulsed displays, or image capture equipment). Accordingly, each LED pixel may be configured to hold its respective operating state with a continuous drive signal, inclusive of PWM, rather than by conventional methods using time division multiplexed signals scanning among groups of pixels that often result in the addition of low frequency components to the drive signals associated with passive matrix addressing. In this regard, each LED pixel may include an active electrical chip or an active electrical element that may include a memory device and the ability to alter a driving condition of the LED pixel based on a state stored in the memory of the active electrical element. In certain embodiments, the continuous drive signal is a constant analog drive current, and in other embodiments where the brightness level may be controlled by pulsed methods such as PWM, the continuous drive signal may refer to a PWM signal that is not interrupted by the time division multiplexed scanning of other LED pixels within the array or within a sub-array. In various embodiments, an active electrical element comprises an integrated circuit chip, an application-specific integrated circuit (ASIC), a microcontroller, or a field-programmable gate array (FPGA). In certain embodiments, active electrical elements may be configured to be programmable or reprogrammable after they are manufactured through various memory elements and logic that are incorporated within the active electrical elements.

As used herein, the terms “active electrical chip,” “active electrical element,” or “active electrical component” include any chip or component that is able to alter a driving condition of an LED based on memory or other information that may be stored within a chip or component. As used herein, the terms “active LED pixel” and “smart LED pixel” may be used interchangeably and may refer to a device that includes one or more LED devices or chips that form a pixel and an active electrical element or chip as described above. In certain embodiments, each LED pixel may comprise a single LED package that is configured as an active LED package that includes multiple LED chips and an active electrical element as described above. In this manner, the number of separate electrical devices needed for the LED display may be reduced, such as the separate electrical devices located on the backsides of LED panels of the LED display as previously described. Additionally, overall operating powers needed for operation of the LED panels may be reduced.

Performance of LED displays continues to advance. Previously, LED displays were more adept for static images such as LED signs rather than dynamic application such as video displays since many of the performance metrics expected for good video image display were lacking. Various performance metrics needed for consideration of LEDs for high-quality video display include resolution, contrast, viewing angle, dynamic range, brightness, frame rate, and color gamut, among others. Recent advancements in LED packages, improvements in LED driver quality, and cost reductions have greatly improved the resolution, among other requirements. As the resolution has increased, the packing density of LED packages, such as on printed circuit boards (PCBs) has also increased and become more complex. The driving of LEDs within LED packages to achieve high dynamic range simultaneously with high frame and refresh rates remains challenging. This is because current driving techniques require remote drivers placed on the opposing side of PCBs containing LED arrays. Packing density constraints dictate that the drivers need to be shared via time division multiplexing techniques, such as raster scan. As the preferred driving techniques for LEDs utilize PWM to set the brightness, ever-higher frequencies are required to achieve high dynamic range. Consequently, the dynamic range is limited by the highest frequency pulse that can be delivered in view of parasitic resistance, capacitance, and inductance. LED packages arranged as pixels for cascade serial communication afford the opportunity to provide drivers local to each LED package, thereby providing improved dynamic range by removing the need for shared drivers and greatly reducing the parasitic resistance, capacitance, and inductance.

For LED displays, a dynamic range of greater than 1000:1 is considered decent while a dynamic range of about 1,000,000:1 is desirable for high-performance applications with localized dimming. PWM is often applied to LEDs through a constant-current driver. In this regard, at any one current the brightness range can be anywhere from a minimum pulse width to a full and constant-on. Furthermore, the PWM period should be such that the blink rate of the minimum pulse isn't noticed, such as a rate of greater than 30 hertz (Hz). In this regard, to have 1,000,000:1 dynamic range, a dedicated PWM driver with a 30 megahertz (MHz) clock is needed. Some display technologies use 60 MHZ, particularly if PWM drivers are multiplexed. However, parasitic power dissipation becomes significant at the higher clock rates, so this solution for high dynamic range may be undesirable.

The human eye can perceive around 20 stops of dynamic range (1,000,000:1) within one lighting condition and can adjust to lighting conditions over a much larger range. Having even more dynamic range is desired to provide for various different lighting levels. Additional needs may include providing for calibration and thermal compensation. In this regard, 16,000,000:1 may be a reasonable target for next-generation displays. If the upper limit for the PWM clock frequency does not provide for the targeted dynamic range, one approach may involve changing the current. However, the switching of the PWM drive from one current to another makes it difficult to match the observed LED brightness from one current to another. Accordingly, there may be a brightness discontinuity associated with the change of current if extreme measures are not taken to calibrate and adjust the PWM signal as compensation. Additionally, performance differences over temperature makes this task even more difficult. Therefore, in most systems where PWM is used, even with the ability to change current, a current is selected and fixed for the whole dynamic range of the display.

The use of PWM to control the brightness of video screens is prevalent. As PWM works by virtue of turning LEDs on and off rapidly, large capacitances in the power supply system are required. Higher powers and lower frequencies require even more capacitance. These requirements may be reduced by having various LED pixels draw power at different times. Conventional solutions involve utilizing remote drivers with time-division multiplexing (TDM) to have the power draw of various pixels occur in different time slots. However, as described above, arranging local drivers for each pixel (or small groups of pixels) has several advantages over conventional TDM methods, but if LED pixels are highly synchronized, the overall power system may be taxed.

According to principles of the present disclosure, LED packages and/or LED pixels with integrated active electrical elements are capable of achieving high degrees of synchronization within a display while also providing PWM phase offsets that alleviate problems associated with LED packages and/or LED pixels drawing power at the same times. LED packages and/or LED pixels include integrated LED drivers configured to drive included LED chips by PWM and provide varying PWM phases to individual LED chips. Separate LED drivers may be incorporated within active electrical elements of each LED package in a display. In various aspects, each LED driver may have a selectable number of PWM periods to be conveyed and the number of PWM periods may be restarted by command. Additionally, one or more of an adjustable or controllable PWM phase, an adjustable time to start PWM output, controllable blanking times and synchronization, and intra-blanking signaling may be provided by integrated LED drivers within each LED package.

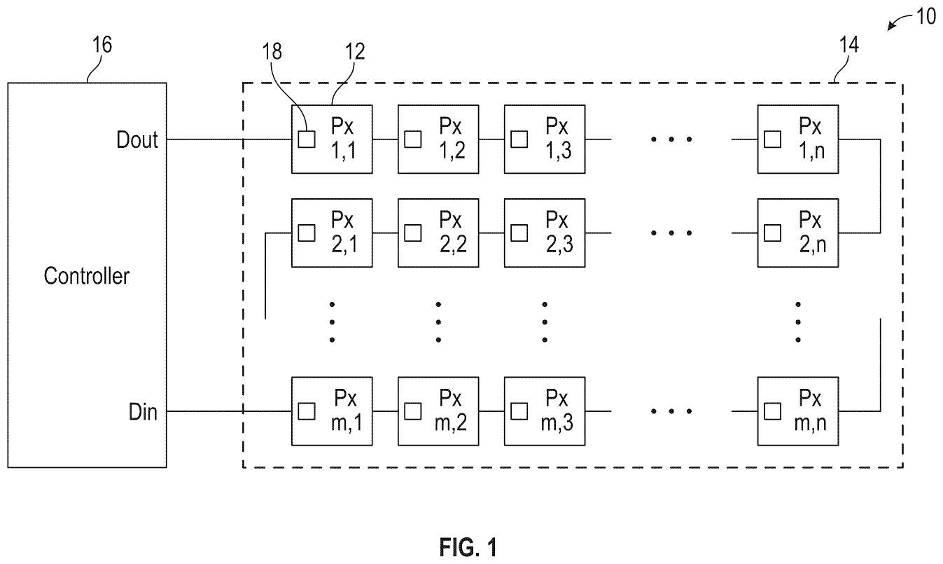

FIG. 1 is a block diagram 10 illustrating a system level control scheme for a lighting device using cascade communication for serially connected LED packages 12. The lighting device may embody an LED display and each LED package 12 may form an LED pixel of the display. For such applications, the terms LED package and LED pixel may be used interchangeably, although it is recognized that an LED package may be composed of several LED pixels formed together in one component. An exemplary LED string 14 arranged for serial communication is indicated by a dashed box in FIG. 1. While only the single LED string 14 is provided in detail, one or more other LED strings may also be coupled with a controller 16. The controller 16 may comprise an integrated circuit, such as one or more of an ASIC, a microcontroller, a programmable control element, and an FPGA. In certain embodiments, the controller 16 may be referred to as a master controller for the LED string 14. In other embodiments, the controller 16 may be a sub-controller to which another master controller (not shown) delegates a set of tasks as it pertains to a larger system. A data signal out (Dout) of the controller 16 may be passed along the LED string 14 in a serial manner, and a return data signal in (Din) may be received back by the controller 16. The signal may include an original clock domain provided by the controller 16 or another master controller as described above. In FIG. 1, each LED package 12, or LED pixel, is provided with a label such as “Px 1,1” where the first number represents a row, and the second number represents a column. Each LED package 12 includes its own active electrical element 18 that is registered and housed therewithin so that each LED package 12 comprises logic for responding to received data signals.

According to the arrangement of FIG. 1, important aspects include delivery of high bit depth data to incorporated LED drivers within each LED package 12 and being capable of converting data effectively to energize the LED chips within each LED package 12 according to expected light output levels with increased dynamic range. As described in greater detail below, LED packages 12 and associated active electrical elements 18 are capable of achieving high degrees of synchronization between pixels while providing for PWM phase offsets to alleviate problems with many LEDs initiating power draw at the same time.

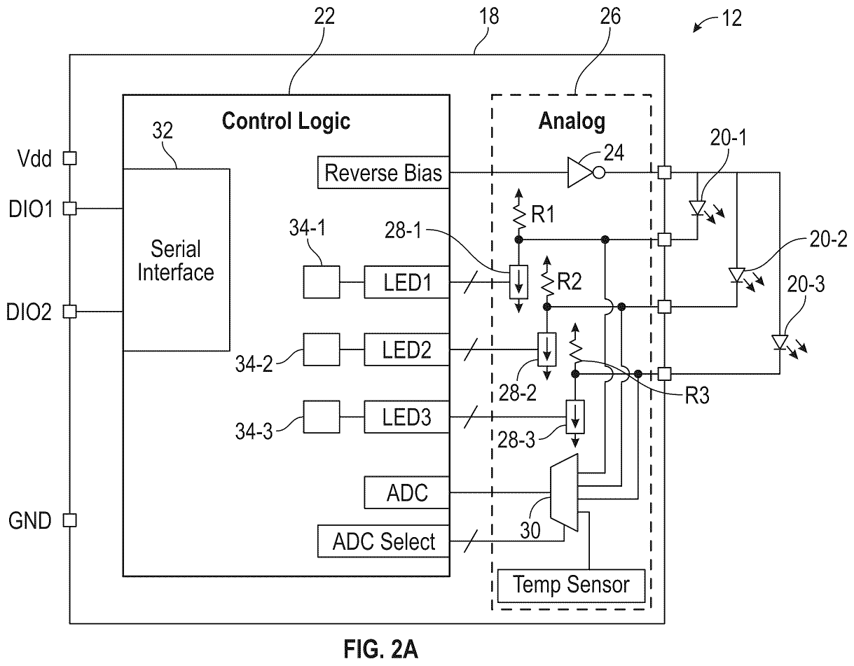

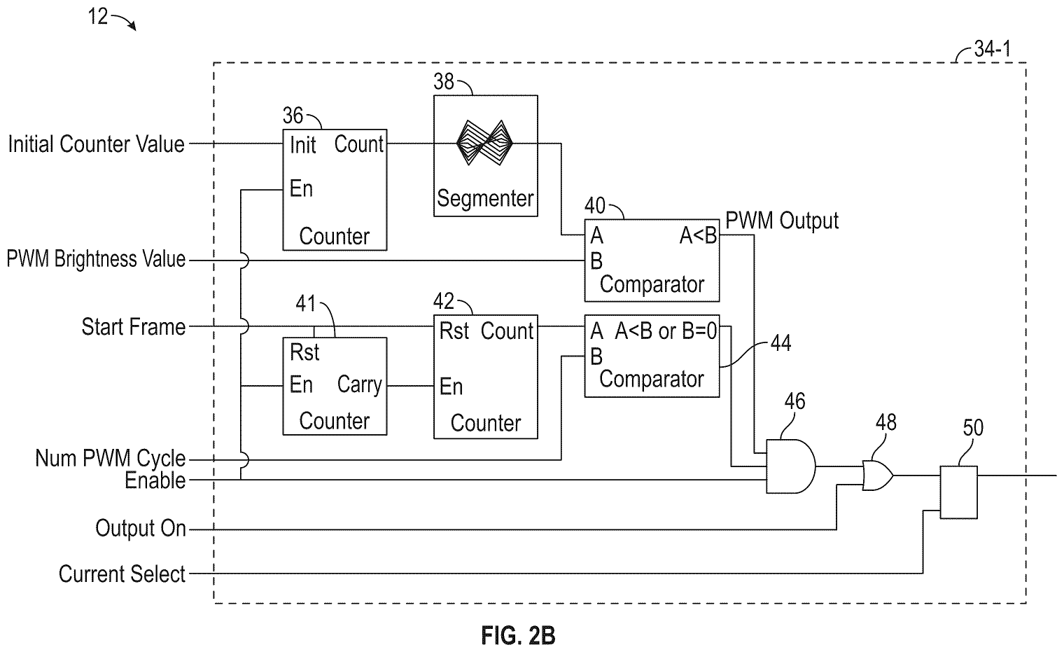

FIG. 2A is a block diagram of an LED package 12 from FIG. 1 capable of providing PWM signals with adjustable PWM phase and/or period according to principles of the present disclosure. The active electrical element 18 may include multiple ports represented by a supply voltage (Vdd), ground (GND), and bidirectional communication ports or digital input/output ports (DIO1 and DIO2) according to embodiments disclosed herein. By having the DIO1 and DIO2 ports configured as bidirectional ports, the active electrical element 18 may advantageously be able to detect an input signal from a communication channel and then assign one of the DIO1 and DIO2 ports as an input port and the other of the DIO1 and DIO2 ports as the output port. Such functionality may be provided by input/output buffers and/or an active switching network internal to the active electrical element 18 and electrically coupled to the DIO1 and DIO2 ports. This provides flexibility in layouts for displays where a plurality of LED packages 12 are connected together for cascade communication. For example, multiple LED packages 12 may be arranged in multiple rows where data cascades from package-to-package along each row and in a serpentine manner from row-to-row as illustrated in FIG. 1. In such arrangements, the bidirectional communication ports allow the LED packages 12 to be mounted in a same orientation and receive and transmit digital communication left-to-right or right-to-left depending on the row. In addition to the four ports of Vdd, GND, DIO1, and DIO2 on the left side of the block diagram, the active electrical element 18 includes four ports on the right side that are coupled with LEDs 20-1 to 20-3 of the LED package 12. In this regard, the LEDs 20-1 to 20-3 are packaged together with the active electrical element 18 in the common LED package 12 to form an individual pixel of a larger display. As used herein, the LEDs 20-1 to 20-3 may also be referred to as LED chips.

Certain elements of the active electrical element 18 are described below; however, it is understood that the active electrical element 18 may include many other components, including memory elements, signal conditioning elements, thermal management, electrostatic discharge elements, clock elements, and oscillators, among others. In FIG. 2A, control logic 22 is arranged to receive input data, execute commands according to a command protocol, provide control signals for operation of the LEDs 20-1 to 20-3, report various voltage levels and/or temperature levels included with output data, and transmit the output data via the DIO1 and DIO2 ports to the next adjacent LED package. The control logic 22 may operate in the digital domain and may include input/output buffers electrically coupled to the DIO1 and DIO2 ports that assign input and output configurations for the bidirectional DIO1 and DIO2 ports.

In certain embodiments, the active electrical element 18 may be configured to provide both forward and reverse bias states to the LEDs 20-1 to 20-3. In this regard, the control logic 22 may include a reverse bias control output signal that, with appropriate active elements, is configured to supply either near-Vdd or near-GND voltage levels to the LEDs 20-1 to 20-3. Since the nomenclature “reverse bias” implies that a high level on the control logic 22 output produces a reverse bias condition, the output signal could simply be coupled with an inverter 24 that is provided in a driver 26 of the active electrical element 18. As such, the LEDs 20-1 to 20-3 may be either forward biased or reverse biased depending on a particular operating state and/or command received by the control logic 22. The inverter 24, or inverter logic element, may have sufficient output characteristics to drive the LEDs 20-1 to 20-3. The driver 26 may be substantially an analog interface of the active electrical element 18 that is electrically coupled with the control logic 22. The driver 26 may include controllable current sources 28-1 to 28-3, which could also be configured as LED sink drivers. Pull-up resistors R1 to R3 may be incorporated to provide paths to Vdd for each of the LEDs 20-1 to 20-3, which aid with the voltage measurement when configured for reverse bias. Each of the current sources 28-1 to 28-3 may be electrically coupled with digital output signals LED1 to LED3 of the control logic 22. The output signals LED1 to LED3 may be provided along multiple wires that are coupled to each of the current sources 28-1 to 28-3 for current selection purposes. The output signals LED1 to LED3 may embody PWM outputs of the control logic 22 for controlling operation of the LEDs 20-1 to 20-3. Each current source 28-1 to 28-3 in FIG. 2A includes multiple current sources at varying current levels to provide varying current PWM control to each LED chip 20-1 to 20-3. In this regard, each current source 28-1 to 28-3 may be referred to as an overall current source for a particular one of the LED chips 20-1 to 20-3 such that each overall current source is composed of multiple individual current sources at different current levels. The driver 26 may also include a multiplexer 30 electrically coupled with an analog-to-digital (ADC) converter and ADC selector of the control logic 22. Additionally, the driver 26 may include an on-chip temperature sensor that is provided through the multiplexer 30. In certain embodiments, the temperature sensor provides thermal compensation for the LEDs 20-1 to 20-3 via a thermal compensation curve and/or thermal shut down.

The active electrical element 18 further comprises a serial interface 32 that embodies a module with circuitry configured to decode and convert the incoming signal of the data stream into a bitstream in a local clock domain, which can be further processed by the control logic 22. In this manner, the serial interface 32 may also be referred to as a digital communication receiving device. The digital communication could be received from a controller (e.g., 16 of FIG. 1) and/or another LED package (e.g., 12 of FIG. 1) in a serial string. The serial interface 32 is further configured to retransmit the decoded and converted bitstream along with modified data to the communication channel to which another LED package or another external element is connected in a manner that is compatible with the overall LED display system.

In certain embodiments, the control logic 22 may include circuitry in the form of one or more PWM processors 34-1 to 34-3 that provide the output signals LED1 to LED3 as PWM signals. A separate PWM processor 34-1 to 34-3 may be provided for each LED chip 20-1 to 20-3, or the PWM processors 34-1 to 34-3 may be combined as single PWM processor for all of the LED chips 20-1 to 20-3. In certain embodiments, the one or more PWM processors 34-1 to 34-3 are configured to receive and/or transform input PWM signals and provide phase offsets in PWM values to the LED chips 20-1 to 20-3 to reduce instances when all LED chips 20-1 to 20-3 are concurrently drawing power or concurrently switching. The one or more PWM processors 34-1 to 34-3 may also be configured to provide a selectable number of PWM periods within a frame of the data stream.

FIG. 2B is a schematic diagram of a portion of the LED package 12 of FIG. 2A illustrating details of the PWM processor 34-1 for the LED chip 20-1. While FIG. 2B is discussed in the context of the PWM processor 34-1 for providing phase delays and/or a selectable number of PWM periods to the LED chip 20-1, it is understood that principles described are also applicable to each PWM processor 34-1 to 34-3 of FIG. 2A. In this manner, the PWM processors 34-2, 34-3 may also be configured for respectively providing phase delays and/or a selectable number of PWM periods to the LED chips 20-2, 20-3 of FIG. 2A in the same manner. Furthermore, for the sake of efficiency, the PWM processors 34-1 to 34-3 may be combined into one processor by sharing common signals and elements. The schematic diagram of FIG. 2B is provided as a conceptual representation of certain elements of the PWM processor 34-1. In practice, other control signals such as resets, clocks, and the like may also be implemented for various functions. While FIG. 2B is described in the context of reordering counter values, the principles described are equally applicable to embodiments where PWM brightness values are reordered instead of the counter values. Other methods of segmenting the PWM such as a lookup table are contemplated as well.

In FIG. 2B, a PWM phase, or arbitrary shift, may be set by way of an initial PWM counter value (Initial Counter Value) that is provided as an input signal (Init) into a first counter 36 of the PWM processor 34-1 and a load signal (not shown). In certain embodiments, the first counter 36 is configured to only count when an enable signal (En) is received. For phase adjustment, the Initial Counter Value may be input as a nonzero initial PWM counter value to the first counter 36. Output count bits (Count) of the first counter 36 may be fed into a segmenter 38 that reorders the output count bits or reorders the counter values by other means. The reordered output count bits are then fed to a first comparator 40 that provides a PWM output by way of a comparison with a PWM brightness value. In FIG. 2B, the reordered output count bits are noted as “A” and the PWM brightness value is noted as “B” at the first comparator 40, with the comparison represented by the expression A<B. For each PWM period, the first counter 36 rolls over and cycles back to the initial counter value. As each cycle of the first counter 36 is a PWM period, the enable signal (En) is conveyed to a second counter 42 which may only count to 3 as a selection between one, two, or three PWM periods per frame. The enable signal for the second counter 42 may be provided by various means such as comparing the first counter 36 with the initial counter value. Another way as shown in FIG. 2B is to have a third counter 41 to count along with first counter 36 but starting from zero so that a carry signal (Carry) of the third counter 41 coincides with the time when the first counter 36 has rolled over and counted for a full PWM period. The output (Count) of the second counter 42 is fed to a second comparator 44 that is implemented for determining whether the PWM output should be turned on based to how many PWM periods have already been displayed within a given frame. Specifically, the second comparator 44 compares the output (Count) of the second counter 42 to an input number signal (Num PWM Cycle) that designates a desired number of PWM periods for a frame. In FIG. 2B, the output (Count) of the second counter 42 is noted as “A” and the Num PWM Cycle is noted as “B” at the second comparator 44, with the comparison represented by the expression A<B or B=0. Accordingly, the PWM processor 34-1 is configured to provide a selectable number of PWM periods (i.e., one, two, or three) based on the comparison performed by the second comparator 44. For instances where the output (Count) of the second counter 42 is zero, the PWM output should be on continuously for the entire frame regardless of the length of the frame. Additionally, the selectable number of PWM periods may be reset or restarted by way of a start frame signal (Start Frame) or command received by the PWM processor 34-1 at the second counter 42 and/or third counter 41 as a reset signal (Rst). By using the Start Frame signal to reset the second counter 42, the PWM output will remain on for the desired number of PWM periods for each frame provided that the length of the frame can accommodate the time required for the PWM periods.

The output of the second comparator 44 is fed to an AND gate 46 that conveys the PWM output signal only if the output (Count) from the second comparator 44 is active and an enable PWM input signal (Enable) is received. The enable PWM input signal may also be used for controlling a start of the blanking time as well as other control needs to turn off the LEDs. An output of the AND gate 46 may be fed to an OR gate 48 for conveyance to the LED driver 26 of FIG. 2A. Additionally, the OR gate 48 may be configured to receive a turn-on input signal (Output On) that provides a separate way to turn on the LEDs regardless of any of the other signals described above. For example, the Output On signal received by the OR gate 48 may be used to create one or more intra-blank flash pulses. Since the LED driver 26 of FIG. 2A may have multiple inputs for current selection, the PWM processor 34-1 may further include a switch 50 that takes a single raw PWM signal (e.g., the PWM Output or the Output On signal) and conveys that signal to one or more current outputs. In FIG. 2B, various lines drawn for input signals may represent single wires (e.g., Enable or Start Frame) while others (e.g., Initial Counter Value, PWM Brightness Value, etc.) may represent busses.

In view of the above, one or more of the PWM processors 34-1 to 34-3 of FIG. 2A may be configured to provide one or more of a selectable number of PWM periods per frame and an adjustable PWM phase to their respective LED chips 20-1 to 20-3. Such capabilities are provided within a structure of the PWM processors 34-1 to 34-3 as illustrated in FIG. 2B. Specifically, the adjustable phase may be provided by way of nonzero PWM counter values for the Initial Counter Value that are fed to the first counter 36, and the selectable number of PWM periods may be provided by way of the second counter 42 and second comparator 44.

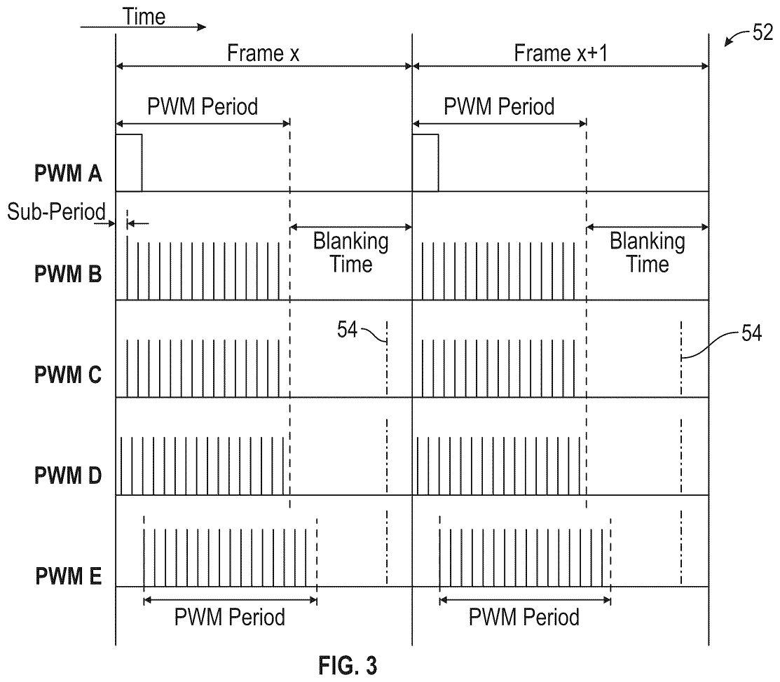

FIG. 3 is an illustration depicting a comparison of various exemplary PWM signals A-E relative to two successive frames 52 according to aspects of the present disclosure. The two successive frames 52 are represented as Frame x and Frame x+1 with time progressing from left to right, and progression of PWM output for each the PWM signals A-E is provided for comparison relative to the Frame x and the Frame x+1. FIG. 3 illustrates only one PWM period within each frame. In other embodiments, the principles disclosed are applicable to longer frames or shorter PWM periods that allow for more PWM periods per frame. Time not available to each PWM output may be considered as a blanking time relative to each frame. Intra-blanking signals 54 may be conveyed to remote equipment by pulsing some or all LEDs in a display with one or more pulses, varying intensities, or other communication patterns within the blanking time. As an example, this intra-blanking pulse can be utilized by three dimensional (3D) glasses to synchronize the left and right shutters, and blanking time may help reduce blur between left and right frames by providing time for the shutter glasses to switch between left and right. In certain embodiments, blanking times and/or adjustable PWM phase times for multiple LED packages of an LED display may be synchronized to an external signal received from other equipment external to the LED display, such as one or more cameras in a video production system.

The PWM A signal is a standard PWM signal that is not divided into sub-periods such that one PWM period per frame is active and the remaining time per frame corresponds to the blanking time. The PWM B and C signals are in phase and have equivalent integrated “on” time to the PWM A signal, but the “on” times are segmented into sub-periods so that blinking artifacts are less noticeable by photographic equipment because of the higher frequency. The sub-periods may be provided by the segmenter 38 as described with respect to FIG. 2B. Being in phase requires more capacitance in the power supply to accommodate larger current spikes to adequately drive many LEDs.

The PWM D signal shows that by adjusting the phase as described above, power may be drawn at different times for various LED chips, thereby reducing capacitance requirements. In certain embodiments, adjusting the phase makes the sub-periods offset from the start of the PWM period such that a “wrap-around” or “rollover” of PWM counter may occur within each PWM period. As disclosed above with reference to FIGS. 2A and 2B, the PWM phase adjustment is achieved by setting the initial PWM counter value. In operation, multiple LED chips and/or multiple LED packages of an LED display may be driven with phase offsets relative to one another during frames to more evenly distribute power draws and capacitance requirements. With the intra-blanking signals 54 being produced by independent signals such as “Output On,” the phase of the intra-blanking signals 54 may have a different or equal phase relationship between components.

The PWM E signal illustrates another example where phase offset may also be achieved adjusting a delay before the PWM period starts. The adjustable delay may correspond with an adjustable length to the blanking time. This delay may be achieved by adding a separate delay timer (not shown) to initiate or continue the PWM counter (e.g., delaying the enable signal (En) of FIG. 2B). In certain embodiments, the initial delay depicted by the PWM E signal may be implemented in combination with the phase adjustment depicted by the PWM D signal where sub-periods are offset from the start of the PWM period.

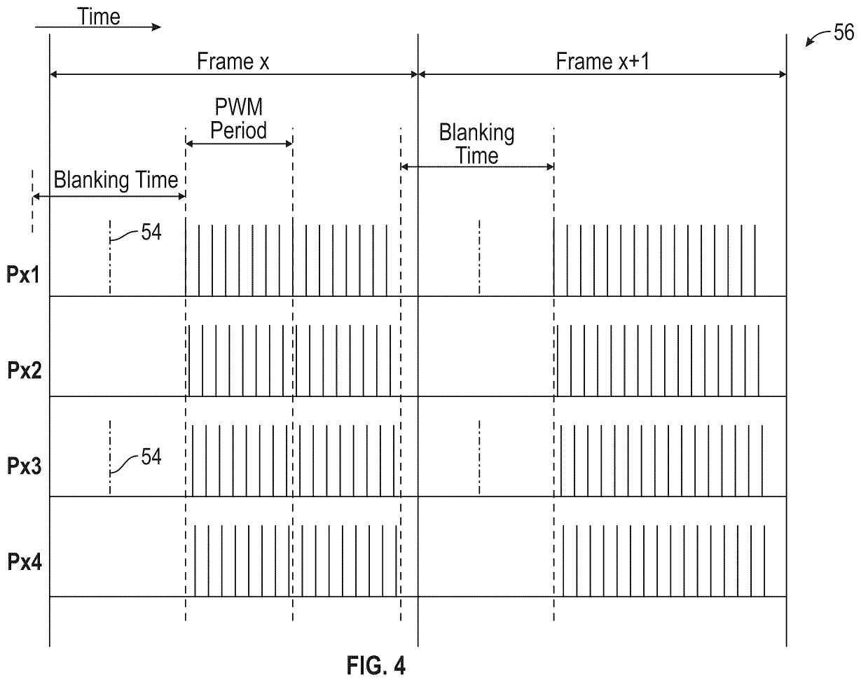

In various embodiments, the blanking time may be positioned at the beginning, end, or within the frame period. In the example of a combination of the PWM D and PWM E signals, the blanking time or a portion thereof is provided at the beginning of each frame. One embodiment described further herein with respect to FIG. 4 involves positioning the blanking time at the beginning of each frame with pulses available within the blanking time, and all times being defined by user-accessible delay values.

FIG. 4 is an illustration depicting two successive frames 56 with two PWM periods per frame for four LED pixels (Px1 to Px4) of an LED display according to aspects of the present disclosure. As illustrated, the blanking time occurs mostly at the beginning of the frame with some overlap from the previous frame in a manner similar to the PWM E signal of FIG. 3. In the embodiment depicted by FIG. 4, every other pixel (e.g., Px1 and Px3) is set to have one communication or intra-blanking signal 54 within the blanking time. For illustrative purposes, FIG. 4 represents 8 sub-periods per PWM period versus the 16 sub-periods per PWM period represented by FIG. 3. Other embodiments may have other numbers of sub-periods, such as 32 or 64 sub-periods. In FIG. 4, two PWM periods are selected per frame. In other embodiments, the number of PWM periods may be selectable by a user based on any number of PWM periods that may fit within each frame. The selectable number of PWM periods may be achieved as described above with respect to FIG. 2B. Depending on the number of PWM periods chosen, the length or duration of the blanking time may also be adjusted.

In the embodiment depicted by FIG. 4, each of the PWM periods for LED pixels Px1 to Px4 are set to be the same while PWM signals to each LED pixel Px1 to Px4 are provided with phase offsets relative to each other. For example, the LED pixel Px1 may have a phase that begins with a beginning of each PWM period, followed by different phase offsets for each of the other LED pixels Px2 to Px4. Accordingly, power draw and capacitance requirements are more evenly distributed throughout each PWM period. The adjustable phases between each of the LED pixels Px1 to Px4 may be achieved by setting different initial PWM counter values as described above for FIG. 2B for each LED pixel Px1 to Px4 and as illustrated by the exemplary phase offset depicted by the PWM D signal of FIG. 3.

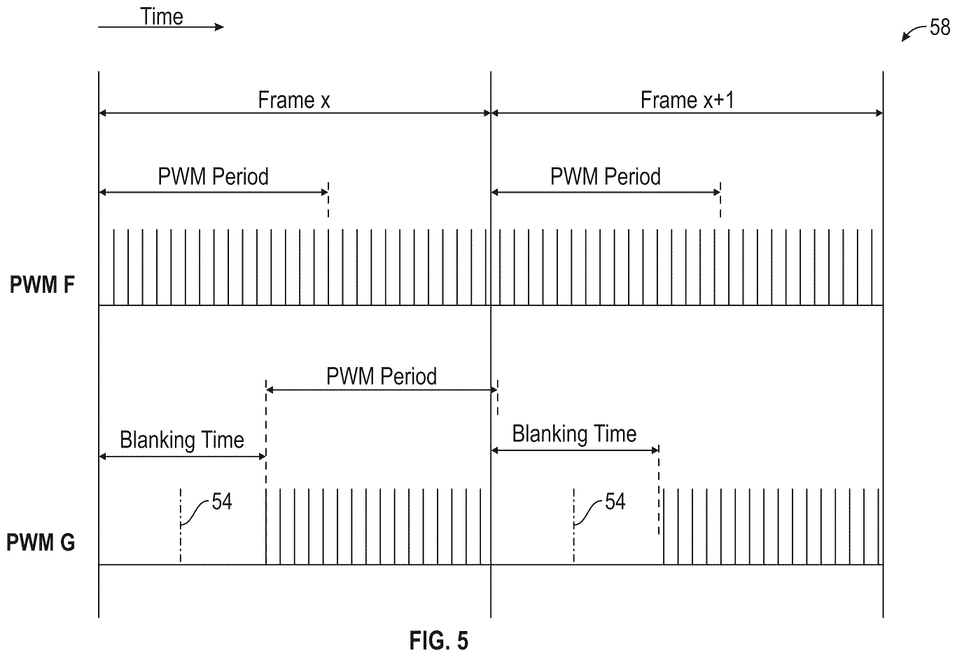

FIG. 5 is an illustration depicting a comparison of exemplary PWM signals F and G relative to two successive frames 58 according to further aspects of the present disclosure. As with FIG. 3, the two successive frames 58 of FIG. 5 are represented as Frame x and Frame x+1 with time progressing from left to right, and progression of PWM output for the PWM signals F and G is provided for comparison relative to the Frame x and the Frame x+1.

The PWM F signal shows an alternative implementation where the PWM signal is not stopped at the end of a set number of frames but continues. For this method, it may be advantageous to accumulate the phase between frames so that phase differences are coming from the frame period and not being an exact integer multiple of the PWM period. Accordingly, the start of the next frame (e.g., Frame x+1) exhibits a phase offset relative to the start of the previous frame (e.g., Frame x). Such an implementation may reduce and/or prevent errors in the color accuracy. The PWM F signal may be achieved by not resetting the PWM counter even if the brightness value is changed between frames.

The PWM G signal shows a combination of blanking as depicted by FIG. 4 with the phase accumulation example of the PWM F signal. In this example, after subtracting the blanking time, the PWM period is slightly longer than the remaining frame (e.g., Frame x). The PWM counter and the PWM output are stopped during the blanking time. This means that the actual PWM period is cut short of full execution and the PWM counter is stopped before it can return to its initial value. After the blanking of the next frame (e.g., Frame x+1), the phase of the PWM counter picks up where it left off with a new initial value, thereby providing a phase offset relative to the start of the PWM period of the previous frame (e.g., Frame x). Also in this example, some frames will have 17 pulses while others will have 16 pulses. While all frames may not exhibit exactly the same intensity, they may average to a correct or intended intensity. While this scenario may not be preferred in all cases, it is advantageous for high frame rates where the PWM period with any blanking is longer than the frame period.

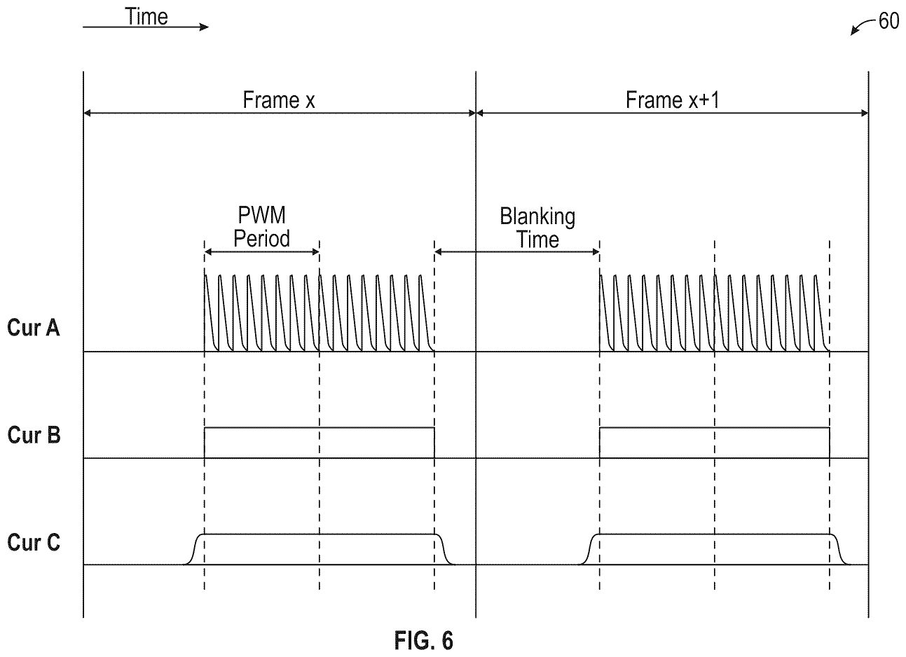

FIG. 6 is an illustration depicting a current draw comparison of a large number or array of components for various PWM signals relative to two successive frames 60 according to aspects of the present disclosure. As with FIG. 3, the two successive frames 60 of FIG. 6 are represented as Frame x and Frame x+1 with time progressing from left to right. A current draw progression or profile for different PWM signals for a plurality of LED pixels is represented as Cur A to Cur C. In certain embodiments, the Cur A to Cur C profiles represent current draws for electrically activating LED chips within each LED package 12 of the plurality of serially connected LED packages 12 as illustrated in FIG. 1 during the frames 60.

The Cur A current draw of FIG. 6 represents a current draw for PWM signals similar to the PWM B or PWM C signals of FIG. 3 where each PWM period is segmented in sub-periods. For the Cur A current draw, PWM signals to all LED pixels start from the blanking in phase. As the array of LED components have various intensities, almost all LED pixels draw current in the beginning of each PWM sub-period regardless of variable brightness levels, and almost none of the LED pixels draw current at the end of each PWM sub-period. As illustrated, the Cur A current draw exhibits notable current spikes with each sub-period due to in-phase PWM signals of each LED pixel.

The Cur B current draw of FIG. 6 represents an improved current draw for an array of LED components with evenly-varying phase shifts of the PWM signals as illustrated with the multiple pixel phase shifted embodiment of FIG. 4. Unless a brightest possible light output is intended, adjusting the phase for various LED pixels effectively spreads current more evenly along each PWM period to provide a reduced overall maximum current level for most brightness levels. Additionally, most of the current spikes as depicted by the Cur A current draw are avoided with current changes only occurring at the beginning and end of active portions of each frame.

The Cur C current draw of FIG. 6 further improves upon the Cur B current draw with further adjustment to the PWM start times or the blanking times. In such embodiments, blanking times for each LED pixel are tailored so that blanking times for some LED pixels start earlier or later than others with most blanking times center about a mean. As illustrated by the Cur C current draw, the aggregate current draw profile for multiple LED pixels exhibits curved edges, such as an S curve or a generally raised cosine profile, or other shapes with reduced sharp current transitions. Such a current draw profile may better match the capability of a power supply for an LED display, reduce system noise and interference, and/or reduce high frequency current components produced by the system. A high frequency current component generally refers to frequency components of a frequency spectrum, and such components are more apt to cause noise and radiate which may cause noise in other systems. Even when displaying the brightest white on all LED pixels, the smoother current transitions of this method yield an improvement.

In view of the above current profiles depicted by FIG. 6, a method of light output control for an LED device, such as an LED display, involves sending a digital communication signal to a plurality of serially connected LED packages (e.g., LED packages 12 of FIG. 1) and electrically activating LED chips within each LED package during a frame such that an overall current draw for LED packages is defined during the frame, and the overall current draw forms a raised cosine profile. Such a raised cosine profile may be provided by individually adjusting a PWM phase and/or a blanking time of individual PWM signals provided by separate PWM processors within each LED package.

The embodiments disclosed herein allow a high degree of synchronization between LED pixels while providing phase offsets to alleviate problems associated with all LEDs drawing power at the same time. The embodiments described herein may also improve color accuracy of LED displays. By having the phase accumulate across frames in certain embodiments, colors may average or integrate accurately to expected colors, but not on a per-frame basis. By having set numbers of PWM periods within a frame and adjusting phase within the periods, accurate color is achieved on a per-frame basis, perhaps with the cost of extra blanking time. Having drivers provide any of the above options allows for optimized designs to match various system requirements while reducing the number of high frequency current components.

As described herein, LED packages are configured for receiving and transmitting digital communication signals, and the LED packages include at least one LED chip and an LED driver configured to drive the LED chip by PWM and provide a varying PWM phase to the LED chip. In various aspects, the LED driver may have a selectable number of PWM periods to be conveyed to the at least one LED chip. The number of PWM periods may be restarted by command. For example, the LED driver may be configured for selection of one, two, or three PWM periods. Additionally, the selection of zero periods may be interpreted as “infinite” to run continuously with exceptions for blanking until commanded to do otherwise. According to various aspects of the present disclosure, LED drivers within LED packages may be configured to provide one or more of an adjustable or controllable PWM phase, an adjustable time to start PWM output, controllable blanking times and synchronization, and intra-blanking signaling. Such intra-blanking signaling may be applicable to 3D shutter glasses and/or other communication purposes. In certain aspects, related methods reduce high frequency current components (e.g., raised cosine power characteristic). Aspects of the present disclosure may be observable in waveform patterns. For example, PWM phase and period counts of various LED pixels may readily observed with light detectors and an oscilloscope.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

1. A light-emitting diode (LED) package configured for receiving and transmitting digital communication signals, the LED package comprising:
an LED chip;
an LED driver configured to drive the LED chip by pulse width modulation (PWM); and
a PWM processor coupled to the LED driver of the LED chip, the PWM processor configured to provide an adjustable PWM phase in a PWM output signal to the LED driver for driving the LED chip.

2. The LED package of claim 1, wherein the PWM processor is configured to receive a nonzero initial PWM counter value to provide the adjustable PWM phase.

3. The LED package of claim 1, wherein the PWM processor is configured to segment a PWM period of the PWM output signal into a plurality of sub-periods.

4. The LED package of claim 1, wherein a period of each frame of the PWM output signal is not an exact integer multiple of a PWM period of the PWM output signal such that a phase of the PWM output signal accumulates between each successive frame, and the phase continues with each successive frame from a point where it was stopped in a previous frame.

5. The LED package of claim 1, wherein:
the PWM processor is configured to provide a blanking time before the start of a PWM period of the PWM output signal; and
the PWM processor is configured to adjust a length of the blanking time to adjust a start time for the start of the PWM period.

6. The LED package of claim 1, wherein:
the PWM processor is configured to provide a blanking time before the start of a PWM period of the PWM output signal; and
the PWM processor is configured to provide an intra-blanking signal to the LED driver during the blanking time.

7. The LED package of claim 1, wherein the PWM processor is configured to provide a selectable number of PWM periods per frame in the PWM output signal.

8. The LED package of claim 7, wherein the PWM processor is configured to receive an input signal designating the selectable number of PWM periods.

9. The LED package of claim 7, wherein the selectable number of PWM periods comprises continuous PWM periods until a stop event.

10. A method of light output control within a light-emitting diode (LED) package, the method comprising:
receiving an input brightness value for an LED chip within the LED package; and
producing a pulse width modulation (PWM) output signal within the LED package for electrically activating the LED chip according to the input brightness value, the PWM output signal comprising an adjustable PWM phase.

11. The method of claim 10, further comprising receiving a nonzero initial PWM counter value to produce the adjustable PWM phase.

12. The method of claim 10, further comprising segmenting a PWM period of the PWM output signal into a plurality of sub-periods.

13. The method of claim 10, wherein a period of each frame of the PWM output signal is not an exact integer multiple of a PWM period of the PWM output signal such that a phase of the PWM output signal accumulates between each successive frame, and the phase continues with each successive frame from a point where it was stopped in a previous frame.

14. The method of claim 10, further comprising:
producing a blanking time before the start of a PWM period of the PWM output signal; and
adjusting a length of the blanking time to adjust a start time for the start of the PWM period.

15. The method of claim 10, further comprising:
producing a blanking time before the start of a PWM period of the PWM output signal; and
producing an intra-blanking signal during the blanking time.

16. A light-emitting diode (LED) display, comprising:
a display panel; and
at least one LED package comprising:
an LED chip;
an LED driver configured to drive the LED chip by pulse width modulation (PWM); and
a PWM processor coupled to the LED driver of the LED chip, the PWM processor configured to provide an adjustable PWM phase in a PWM output signal to the LED driver for driving the LED chip.

17. The LED display of claim 16, wherein the PWM processor is configured to receive a nonzero initial PWM counter value to provide the adjustable PWM phase.

18. The LED display of claim 16, wherein the PWM processor is configured to segment a PWM period of the PWM output signal into a plurality of sub-periods.

19. The LED display of claim 16, wherein a period of each frame of the PWM output signal is not an exact integer multiple of a PWM period of the PWM output signal such that a phase of the PWM output signal accumulates between each successive frame, and the phase continues with each successive frame from a point where it was stopped in a previous frame.

20. The LED display of claim 16, wherein:
the PWM processor is configured to provide a blanking time before the start of a PWM period of the PWM output signal; and
the PWM processor is configured to adjust a length of the blanking time to adjust a start time for the start of the PWM period.

21. The LED display of claim 16, wherein:
the PWM processor is configured to provide a blanking time before the start of a PWM period of the PWM output signal; and
the PWM processor is configured to provide an intra-blanking signal to the LED driver during the blanking time.

22. The LED display of claim 16, wherein the PWM processor is configured to provide a blanking time during each frame of the PWM output signal, and the blanking time is synchronized to an external signal received from other equipment external to the LED display.

23. A method of light output control for a light-emitting diode (LED) device, the method comprising:
sending a digital communication signal to a plurality of serially connected LED packages; and
electrically activating LED chips within each LED package of the plurality of serially connected LED packages during a frame such that an overall current draw for the plurality of serially connected LED packages is defined during the frame, and the overall current draw forms a profile with curved edges.

24. The method of claim 23, wherein electrically activating LED chips within each LED package of the plurality of serially connected LED packages comprises:
providing a first pulse width modulation (PWM) phase for a first LED package of the plurality of serially connected LED packages; and
providing a second PWM phase for a second LED package of the plurality of serially connected LED packages, wherein the second PWM phase is offset from the first PWM phase.

25. The method of claim 24, wherein the first PWM phase is provided by a first PWM processor of the first LED package, and the second PWM phase is provided by a second PWM processor of the second LED package.

26. The method of claim 24, further comprising:
providing a first blanking time for the first LED package within the frame; and
providing a second blanking time for the second LED package within the frame, wherein a start time or an end time of the second blanking time is offset from a start time or an end time of the first blanking time.

27-57. (canceled)
